(19) United States
(12) Patent Application Publication
(10) Pub. No.: US 2004/0015390 A1
(43) Pub. Date: Jan. 22, 2004

(54) Working process administering system and method

(76) Inventor: Masaaki Sakuta, Tokyo (JP)

Correspondence Address: YOUNG LAW FIRM, A PROFESSIONAL CORPORATION, 4370 ALPINE ROAD SUITE 106, PORTOLA VALLEY, CA, 94028

(21) Appl. No.: 10/332,942

(22) PCT Filed: Jun. 15, 2001
(86) PCT No.: PCT/JP01/05148

(30) Foreign Application Priority Data
Jul. 12, 2000 (JP) 2000-211868

(51) Int. Cl. G06F 17/60

(52) U.S. Cl. 705/11; 705/10

(57) ABSTRACT

A working process administering system for raising a working efficiency by using a learning effect, comprising: means for deciding a necessary man-hours and a working schedule necessary for completing the work; means for deciding a first curve or a growth curve predicting a working performance: means for predicting a second curve or a quadratic curve of a man-hours distribution; means for determining a third curve by calculating the sum of the first curve and the second curve; and means for adding a shortage to the second curve when a difference is present between a fourth curve indicating the actual performance and the third curve when they are compared.

### TECHNICAL FIELD

The present invention relates to a system for administering working process for rising a working efficiency by use of learning effects.

### BACKGROUND ART

In the conventional method of drafting a plan or schedule such as educational planing or a hand-work production planing, the plan or schedule has been mostly prepared by uniformly dividing the total educational or production quantity by the total number of the days from education or work starting day until education or work completion day if the predetermined quantity of education or work is completed by the education completion due date or the production due date. Notwithstanding, a possibility of discontinuation on halfway and miscarrying or failing the implementation of the planing or schedule will be increased as the difficulty of the issue and the working time becomes greater. Namely, the uniform division of the given sum issue into daily respective issues is not so effective for solving the above problem, while the daily issues are uniform. As shown in FIG. 3(a), achievement of the uniform issues for every times causes no problem. If, however, it is difficult to achieve this, then the work will, thereafter, be accumulated and thus an accumulative work quantity will be increased. For the human work, the learning effect makes a large change in work efficiency between a work initiation time and the middle time between the work initiation time and a work completion time. Namely, the work efficiency is low at the work initiation time. The work efficiency becomes high at the work middle time. The work efficiency again becomes low at the work end time. The uniformity of the daily work quantity is insufficient for improving the work efficiency. Further, in case of the uniform daily issue, a correctable parameter is a daily working quantity. If the daily working quantity is reduced, then the delivery date will be delayed, thereby making it difficult to achieve the issue within the determined due date. Therefore, as shown in FIG. 3(b), even the target due date is set, if it is difficult to achieve the target in the initial stage, then the delivery date will be delayed.

Accordingly, in order to solve the above problem, the present invention is to provide a system and a method for drafting and administering the working schedule in consideration of the learning effects.

### DISCLOSURE OF THE INVENTION

In order to solve the above issue, the present invention provides a system for administering the working process, for rising the working efficiency by use of the learning effects, which includes means for deciding necessary process number and working schedule for completing the work; means for deciding a first curve as a growth curve which represents a predicted accumulative working amount; means for deciding a second curve as a secondary curve which represents a planned process number per one day; means for deciding a third curve by normalizing the first and second curves and calculating a sum of the normalized first and second curves; and means for adding a shortage to the second curve if a difference is present between a fourth curve which represents a working result and the third curve.

It is possible that the working is continued if, in view of a working result of working in a term of 1/10 of a full term of a working schedule, said fourth curve is identical with or above the third curve, while the working is discontinued if, in view of the working result, said fourth curve is below the third curve. A logistic curve may be used as the growth curve.

The present invention provides a method for administering the working process, for rising the working efficiency by use of the learning effects, which includes the steps of deciding necessary process number and working schedule for completing the work; deciding a first curve as a growth curve which represents a predicted accumulative working amount; deciding a second curve as a secondary curve which represents a planned process number per one day; deciding a third curve by normalizing the first and second curves and calculating a sum of the normalized first and second curves; and adding a shortage to the second curve if a difference is present between a fourth curve which represents a working result and the third curve.

It is possible that the working is continued if, in view of a working result of working in a term of 1/10 of a full term of a working schedule, said fourth curve is identical with or above the third curve, while the working is discontinued if, in view of the working result, said fourth curve is below the third curve. The growth curve may comprise a logistic curve.

### BRIEF DESCRIPTION OF DRAWING

FIG. 1 is a schematic view of a system for administering a working process in accordance with the present invention.

FIG. 2 is a flow chart of a method of administering a working process in accordance with the present invention.

FIG. 3(a) is a graph showing days required for completing reading works at a constant reading speed in accordance with the prior art, and FIG. 3(b) is an enlarged view thereof.

FIG. 4 is a graph showing a growth curve for every 25 days.

FIG. 5 is a graph showing a growth curve for every 12.5 days.

FIG. 6(a) is a graph showing a smoothed growth curve, FIG. 6(b)-1 shows an initial fragment of the growth curve, and FIG. 6(b)-2 shows an end fragment of the growth curve.

FIG. 7 is a graph showing the growth curve.

FIG. 8 is a graph showing a working time per one day.

FIG. 9 is a graph showing a variation in the cumulative working time for respective learning levels.

FIG. 10 shows a first curve (SS) and a second curve (A) in accordance with the present invention.

FIG. 11 shows a graph (A-curve, A′-curve, A″-curve) per one day for respective learning levels in accordance with the present invention.

FIG. 12 is a graph showing an unamended third curve (SS+A) and an amended third curve (SSA), wherein the third curve is a sum of the first and second curves in accordance with the present invention.

FIG. 13 is a graph showing a hatched mark which represents a difference between the third curve (as amended) SSA and the third curve SS in accordance with the present invention.

FIG. 14 is a graph showing a case of a sufficiently high level of previous-understanding.

FIG. 15 is a graph showing another case of none of previous-understanding.

FIG. 16 is a graph showing still another case of an intermediate level of previous-understanding.

### BEST MODE FOR CARRYING OUT THE INVENTION

Details, advantages and characteristics other than the above of the present invention will be apparent from the following embodiments with reference to the accompanying drawings.

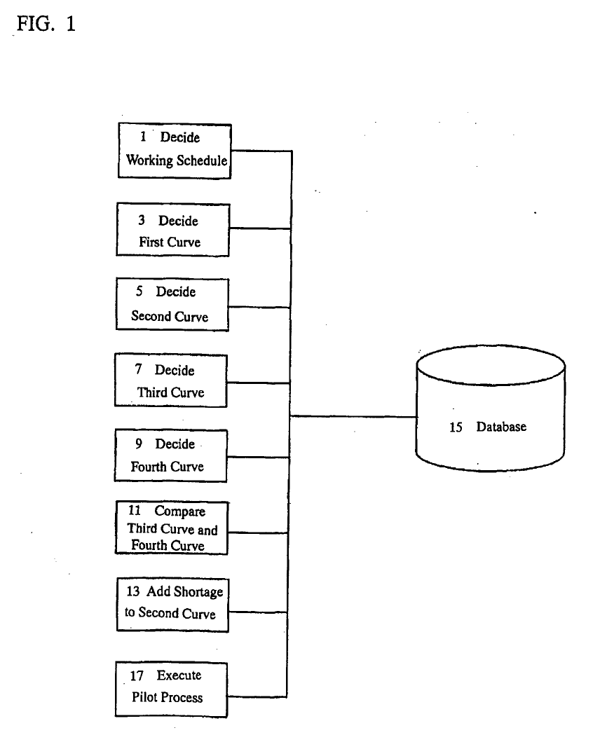

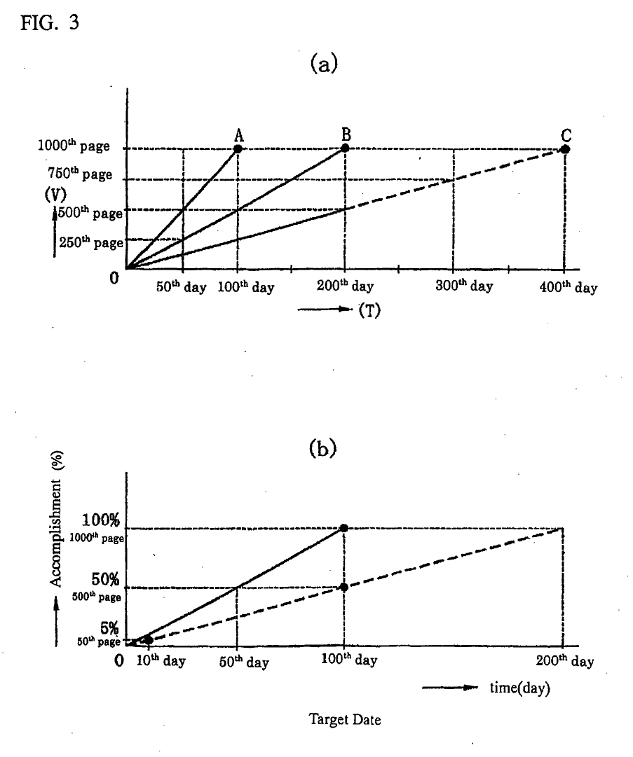

The embodiment of the present invention will hereinafter be described with reference to FIGS. 1, 3, 4, 5, 6, 7, 8, 9, 10, 11, 12, 13, 14, 15 and 16.

A method of administrating the working process will be described in case that the working process is a book-reading process.

A structure of the system in accordance with the present invention is shown in FIG. 1.

The present system includes a working schedule deciding means 1, a first curve deciding means 3, a second curve deciding means 5, a third curve deciding means 7, a fourth curve deciding means 9, an adding means 13 for adding a shortage to a second curve, a data base 15, and a pilot process execution means 17. Those are electrically connected to each other.

The working schedule deciding means 1 decides a working completion date based on a working amount and a working requester. The working schedule deciding means 1 stores the working amount, the name of the working requester, the decided working schedule and the decided working completion date into the data base 17. If the working schedule is decidable based on the working amount, then the working schedule deciding means 1 decides the working completion date. If the working schedule is decidable by the working requester, then this decision is made by a request of the working requester. In this embodiment, a book-reading process for reading a book with 1000 pages will be completed by 100 days which are decided by the working requester.

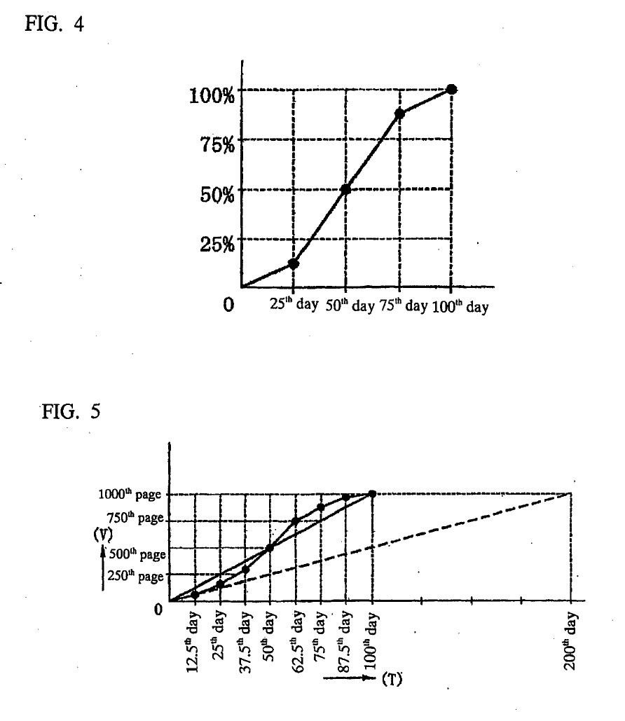

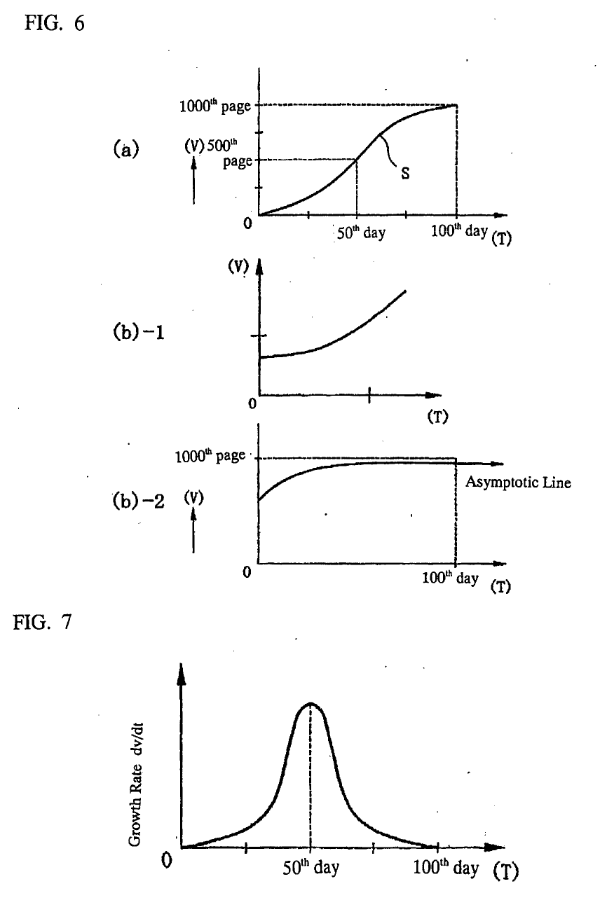

The first curve deciding means 3 is to represent a predicted working result with a growth curve. The first curve deciding means 3 stores the decided first curve into the data base 17. The understanding level for the working will be increased along the growth curve shown in FIG. 4, for which reason the growth curve is used for predicting the working result. In FIG. 4, a horizontal axis represents the schedule, and a vertical axis represents the number of pages. The understanding level is usually ¼ of the initial one, wherein it is not very increased until 250 pages. Namely, the understanding speed of the reader is slow until the first quarter of all pages. After passing this state, the understanding speed of the reader is increased rapidly until 750 pages. The fourth quarter of the book is the conclusion of the book, for which reason the understanding level and the reading speed become slow. Case of that the time unit is ⅛ of all is shown in FIG. 5. The growth curve, in which the measuring points are increased, is shown in FIG. 6(a).

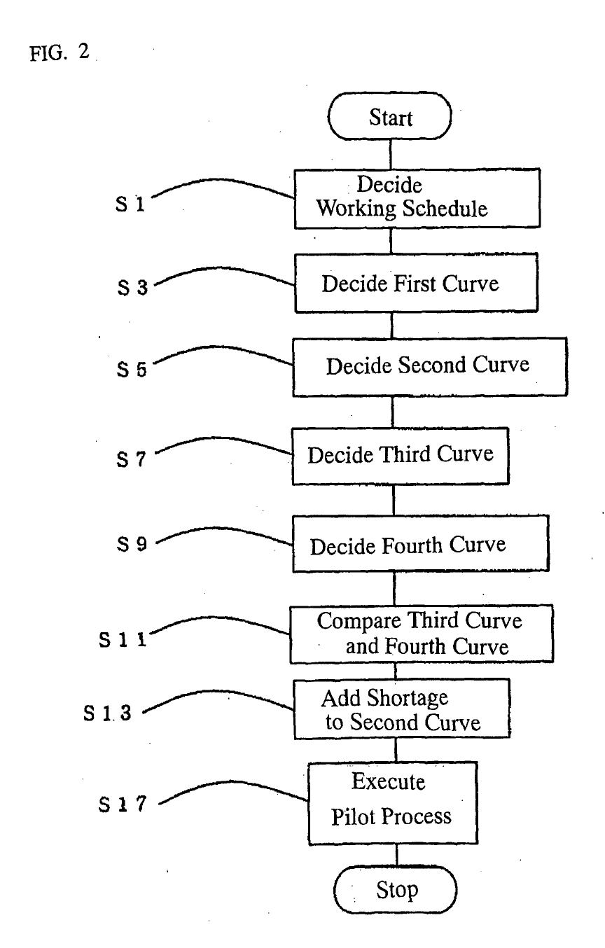

The growth curve takes non-zero of the resulting quantity (Q) when the time (T) is zero (FIG. 6(b)-1). The initial value at the time (T) of zero does mean obtaining and purchasing books or the working quantity for motivation if the book has been obtained. At the working completion day, the growth curve is converged so as to become close to a target value limitlessly but not achieve the target value (FIG. 6(b)-2). Normally, the growth curve is represented to be the logistic curve. The growth final stage value is represented by V_{F}, and γ is a constant and t is a time, wherein the growth curve Vt is represented by the following equation:

Vt=[Vt/(1+V_{F}exp(γt))]

FIG. 7 shows a graph of the growth rate which indicates the growth speed as the criterion of the growth speed. The graph in FIG. 7 represents the growth rate curve. It is characteristic that the growth rate curve varies over times. The following equation represents the growth rate curve and is differentiated with time.

(dV/dT)=Vₜγ(V_{F}−Vₜ)/V_{F}

The above equation means that the result “V” is proportional to the product of a result Vₜ at a time “t” and a ratio of a difference (V_{F}−Vₜ) between the final result V_{F}, and the result Vₜ at the time “t”, provided that Vₜ+VΔₜ=V_{t +Δt}.

The growth rate curve is applied to the book-reading. It takes a time for reading the first ten pages and understanding the same. Namely, if the inexperienced working is performed, then it takes a time to understand and practice the experience. The working speed or the reading speed will increase increasingly by the experience and practice based on the learning effects. The increase in the reading speed and the increase in the number of the working-repeat time result in the reduction of the working time. The remaining one quarter of the book corresponds to the conclusion of the book and thus has a concentration of contents, for which reason the reading speed is reduced. V_{F}, is decided from the predicted resulting quantity and the date of delivery. γ is a constant decided from the past actual result.

As described above, the first curve deciding means 3 prepares a working result prediction curve from the above growth curve.

The second curve deciding means 5 is to calculate a curve which indicates the working time per the same working. The second curve deciding means 5 stores the calculated second curve in the data base 17. The working time will increase for the same working until the learning level will increase. The every date repeat of the working improves the learning level, thereby reducing the working time. Finally, the working time is limitlessly closed to zero. If for a part of the working contents, the learning level has already been high before working, then the working time in the initiation of the working is shorter than the unskilled working. A peak of the increased working time is lower than another peak of the increased working time in case of no practice or no experience before starting the working.

Depending upon the learning level in starting the work, a y-fragment in starting the work is decided, whereby a parabola line has a top M and a final completion point P. The second curve is the parabola. Namely, for a moment of an object in a constant gravity field, the parabola as the second curve is calculated, which includes a constant point upon fixing the initial vector and locus points of the object which has such a property that the parabola always keeps a kinetic energy and a potential energy to be minimum respectively until arriving the final completion point P.

(½)mV_{oy}²+(½)mVₒₓ²+mgy=c

The above equation is obtained in accordance with the low of energy conservation, where an initial velocity is Vo, (Vox, Voy) coordinate is (x, y) and any air resistance is absent and a gravity constant is “g” and a time is “t”. y coordinate is given by:

y=V_{oy}t−(½)gt²

x=Vₒₓt

y=(V_{oy}/Vₒₓ)x−(g/2Vₒₓ²)x²

The above equations are the second curve if the learning level is 100 percents.

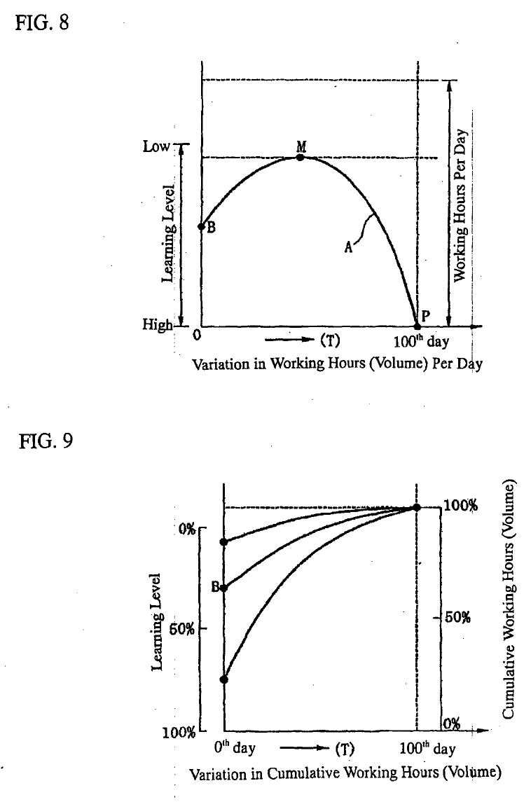

FIG. 8 shows the case that the learning level is B-percents. In FIG. 8, the vertical axis represents the working time, and the horizontal axis represents the necessary days. In case of a high leaning level, the result can be obtained even the working time per a day in the initial term is short. In contrast to this, in case of a low leaning level, the working time in the initial term will unwillingly be long. In FIG. 8, a parabola is drawn so as to include the point-B, the intermediate point-M and the completion point-P. An area surrounded by this curve, the x-axis and the y-axis represents a total cumulative working quantity over a full working time.

A graph representing the total working quantity cumulated over times is shown in FIG. 9. The cumulative working quality varies depending on the initial skill level or the learning level at starting the work. The high leaning level or the high skill level, a sufficient knowledge about the book, highly trained reading skill for working or reading will obtain a high efficiency and a result in a short time to promote the understanding and increase the quality as read.

The second curve deciding means 5 calculates an equation 6 upon entry of an initial state of the learning level, wherein a sufficiently high skill state by repeated reading works is a 100-perents understood state, while no previous knowledge nor skill level state is 0-percent understood state. The initial speed is so set that the learning level becomes 100 percents at the completion point “P”, and takes a maximum peak at the intermediate point as also that Voy is equal to Vox.

The second curves in cases of different learning levels are shown in FIG. 11. The curve A″ is of the case that the initial skill level at starting the work is 0 percent. The curve A′ is of the case that the initial skill level at starting the work is 50 percents. The curve A is of the case that the initial skill level at starting the work is more than 0 percent and less than 50 percents. As the learning level is moved from 100 percents to 0 percents, a parabola also varies but which always takes a maximum point M and always arrives at the point P. Each area surrounded by each of parabolas A, A′ and A″, the X-axis and the Y-axis.

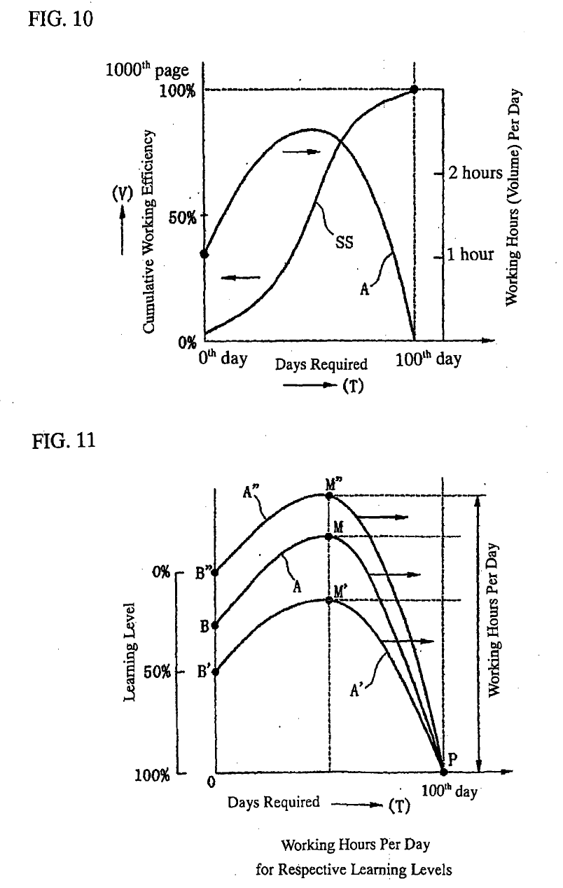

The third curve deciding means 7 is to decide a third curve, wherein the first and second curves are respectively normalized and then added to each other to obtain the third curve. The third curve deciding means 7 stores the third curve into the data base 17. A graph of superimposition of the first and second curves is shown in FIG. 10. At first, a working time for 100 days is decided. If 1.5 hours are presumed to be the averaged time per one day, then total time for 100 days is 150 hours. Namely, the area surrounded by the curve A, the X-axis and the Y-axis corresponds to 150 hours. The reading time per one day will increase from 1 hour to 2 hour in the term of the first day to twenty fifth day. At the fiftieth day, the reading time takes a peak of about 2.5 hours, thereafter the reading time is reduced until one hundreds day. In FIG. 10, the total time is 150 hours. If the total time is 100 hours, the area surrounded by the curve A, the X-axis and the Y-axis corresponds to the total time of 100 hours. The daily reading time per one day is decided upon deciding a total reading time frame. A point A of the first day is so decided that the parabola takes the maximum at a point of one hundredth day and 1000 pages. In the above described manner, SSA curve can be calculated.

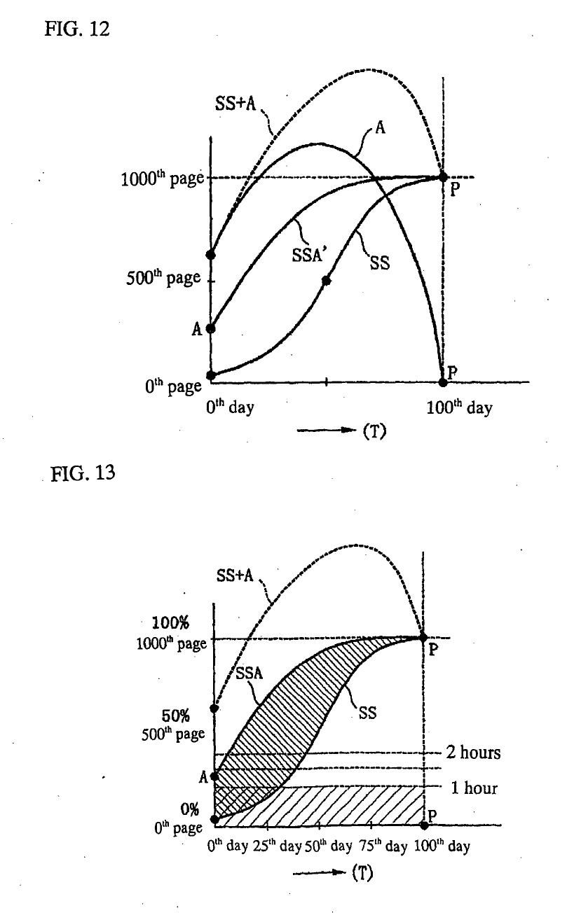

In FIG. 12, a curve SS+A, which is obtained by superimposition of the first curve SS and the second curve A, is shown. A smooth curve SSA in FIG. 13 could be plotted under conditions that an area surrounded by the curve SS+A and the curve SS in FIG. 12 is equal to an area surrounded by the curve SSA and the curve SS.

In FIG. 13, the curve SSA is considered to be a relationship between a reading (working) time (A) per one day and a result (B). The first curve SS is the growth curve, wherein the reading result is not large, and the growth rate is small until twenty fifth day from starting the reading work. In the vicinity of the fiftieth day from starting the reading work, the reading result is increased and the growth rate is increased. If a total reading time is 100 times for total days of 100 days, then an area surrounded by the third curve SSA and the first curve SS in FIG. 13 does correspond to 100 hours (the drawing shows about 150 hours).

The reason for establishing the SSA curves in FIGS. 12 and 13 are that parabola may be decided by giving an air resistance and an initial vector, in view that parabola represents a moment of an object when carrying the same as far and high as possible. The growth curve may be understood as representing the natural phenomenon (for example, representing the accumulative number of read pages), in view of which a distribution of human work should be done according to the growth curve to cause a smooth and waste-less progression and obtain a result. The consideration, that the product as hardware (accumulative reading quantity) and the quantity of knowledge and capability as software inputted (reading time per one day) decide the next product as hardware (reading page per one day), would be a collaboration between an accumulation R of a minimum potential energy (accumulative reading quantity) and a distributed input of knowledge according to locus of parabola with a minimum resistance energy (reading quantity per one day).

One of the objects of the third curve SSA is to check any unbalance between the result and the knowledge-distributed input.

Namely, it is intended to check whether the first check item takes the growth curve B too large. If the growth curve has been taken to be larger than the present status, it is necessary to reduce the same.

The second check item is whether an accumulative evaluation at a start point of the curve A is taken too large. If the accumulative evaluation has been taken too large, then it is possible that the result could not achieve and the completion is not available until the completion scheduled day.

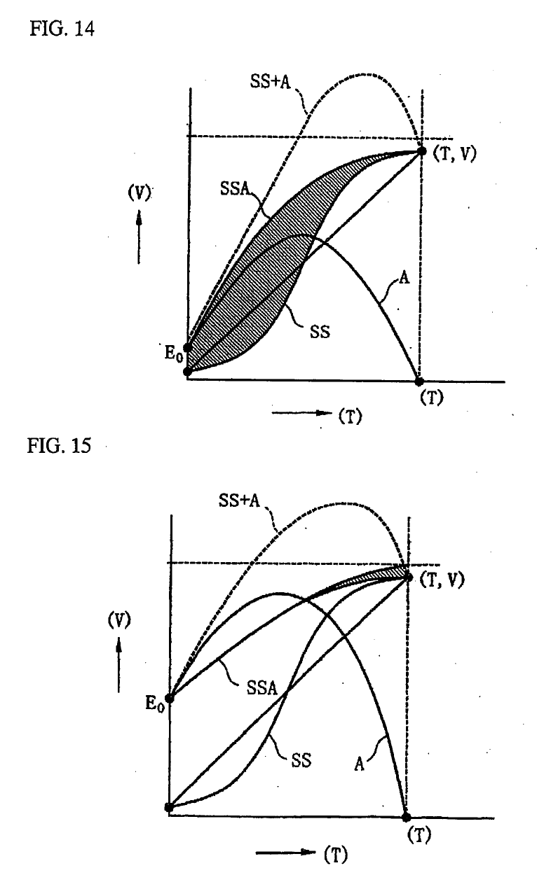

Subsequently, the third curves in three cases different in understanding level are shown in FIGS. 14, 15 and 16.

The first is shown in FIG. 14, wherein the initial understanding level (T=0) is sufficiently high. The SS-curve has a target point (T, V) and extends along a diagonal line of a square having four corners (0, 0), (T, 0), (0, V) and (T, V). The A-curve is a parabola which has a target point of (V=0, T=T) and a start point (V=E₀, T=0). An integration of this parabola for T from 0 to T corresponds to an area surrounded by the A-curve, and the T-axis and the V-axis, wherein the area represents a predetermined total working time. The curve SS is added with the curve A to draw the curve SS+A. A repeat of preparation and review may increase the growth rate but finitely. After passing over the top of the growth rate curve, the growth rate will decrease. Under the condition of restriction to the total working time frame, the curve SSA shown in FIG. 14 can be obtained in the manner of preparing the SSA curves shown in FIGS. 12 and 13.

The second is shown in FIG. 15, wherein the initial understanding level (T=0) is completely none. Similarly to the first, the SS-curve has a target point (T, V) and extends along a diagonal line of a square having four corners (0, 0), (T, 0), (0, V) and (T, V), provided that E₀ at T=0 takes a value of one half of the target value (=V). In addition, a parabola is drawn to a target (T, V=0). The SSA curve can be obtained by superimposition of the SS-curve and the A-curve in the same process as shown in FIG. 14.

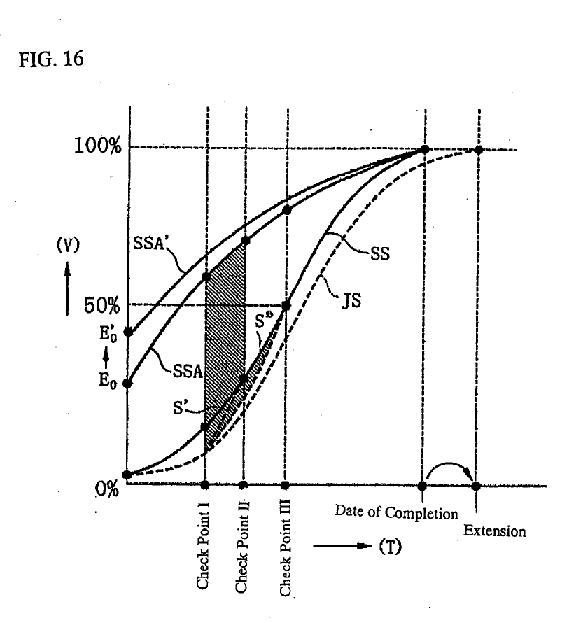

The third is shown in FIG. 16, wherein the initial understanding level (T=0) is middle level. E₀ at T=0 takes a value slightly lower than an intermediate point of the E-scale.

The fourth curve deciding means 9 is to present a fourth curve JS which indicates the result in FIG. 16. The fourth curve JS as the result is checked at its value at check point. The fourth curve deciding means 9 stores the fourth curve JS into the data base 17.

The means 11 for comparing the third and fourth curves is to compare the third and fourth curves stored in the data base 17. The means 11 for comparing the third and fourth curves is to obtain a difference between them from the fourth curve JS and the third curve SSA. The means 11 for comparing the third and fourth curves stores the difference into the data base. It is possible to judge whether or not any satisfactory result could be achieved by comparing the both curves at check points. In FIG. 16, at the check point I, the JS-curve lies below the SS-curve even the reading is made according to the SSA-curve.

The adding means 13 for adding a shortage to the second curve is to continue the work if the difference between the fourth curve JS and the third curve SSA is positive or zero, while to add a shortage result to the fourth curve if the difference between the fourth curve JS and the third curve SSA is negative. A further check point II is set following to the check point I. The curve JS is amended so as to give a chance to increase the reading time (working time) for riding onto the SSA-curve until the further check point II, whereby the shortage can be compensated.

Subsequently, at the check point II, a comparison between the result and the schedule SSA-curve is made. The current result line is extended so as to judge whether or not the graph will achieve the completion point on the completion date. If achieving the completion point, the reading is continued with the current time distribution. If not achieving the completion point, the daily reading time per one day is increased.

Possible causes may be erroneous estimation of the initial understanding level. Namely, the value on Y-coordinate at the start point is too small. In this case, it is necessary to correct E₀ upwardly and also increase the daily reading quantity per one day for the purpose of rendering the curve arrive at the point P. In FIG. 16, E₀ is shifted upwardly along the Y-axis and new point E₀ is set in order to prepare a new curve SSA′. Based on the SSA′ curve, the following operations will be made.

The above comparison between the results and the schedule will be made for each check point in view of need to change the curve SSA, and the curve SS. The change is made after confirming the change due date.

The pilot process execution means 17 once executes only a part of the process, for example, 10% so that if at this time, a difference between the curve JS and the curve SS+A is zero or positive, then the pilot process execution means 17 will continue to execute the remaining 90% part. If the difference between the curve JS and the curve SS+A is negative, then the pilot process execution means 17 will discontinue the process, and discover the cause and find an executable solution prior to the re-execution.

The process for the system of the present invention will subsequently be described with reference to FIG. 2.

The first is a working schedule deciding process (S1). The working schedule deciding process (S1) is a process for deciding the working schedule.

The second is a first curve deciding process (S3), which is to obtain a growth curve which predicts the working result.

The third is a second curve deciding process (S5), which is to decide a curve which indicates the daily working time per one day.

The fourth is a third curve deciding process (S7), which is to decide a third curve which is a sum of the first and second curves.

The fifth is a fourth curve deciding process (S9), which is to decide a fourth curve on which results are described.

The sixth is a third-to-fourth-curve comparison process (S11) which discontinues the current work if a difference between the third and fourth curves is large, and also continue the current work if the difference is small and tolerant.

The seven is a shortage-second-curve-adding process (S13) for adding a shortage to the second curve. The shortage-second-curve-adding process (S13) is to compensate the first curve if the difference between the third and fourth curves is large in the above sixth, and additionally compensate the third curve if the difference is larger.

The eighth is a pilot process execution process (S17) (FIG. 1). The pilot process execution process (S17) once executes only a part of the process, for example,10% so that if at this time, a difference between the curve JS and the curve SS+A is zero or positive, then the pilot process execution means 17 will continue to execute the remaining 90% part. If the difference between the curve JS and the curve SS+A is negative, then the pilot process execution process (S17) will discontinue the process, and discover the cause and find an executable solution prior to the re-execution.

The use of the above method allows complete execution within the due date with correction if the problem is small, or withdraw if the problem is large.

The present invention allows a working schedule to be drafted and managed in consideration of the learning effects.

It is also possible that the working result is fed back to the planing or scheduling in order to reduce any possible error and to increase the efficiency.

1. A system for administering a working process for rising a working efficiency by use of learning effects, comprising:
means for deciding a necessary process number and a working schedule for completing the work;
means for deciding a first curve as a growth curve which represents a predicted accumulative working amount;
means for deciding a second curve as a secondary curve which represents a planned process number per one day;
means for deciding a third curve by normalizing the first and second curves and calculating a sum of the normalized first and second curves; and
means for adding a shortage to the second curve if a difference is present between a fourth curve which represents a working result and the third curve.

2. The administering system as claimed in claim 1, wherein a working is continued if, in view of a working result of working in a term of 1/10 of a full term of a working schedule, said fourth curve is identical with or above the third curve, while the working is discontinued if, in view of the working result, said fourth curve is below the third curve.

3. The administering system as claimed in claim 1 or 2, wherein the growth curve is a logistic curve.

4. A method for administering a working process for rising a working efficiency by use of learning effects, comprising the steps of:
deciding a necessary process number and a working schedule for completing the work;
deciding a first curve as a growth curve which represents a predicted accumulative working amount;
deciding a second curve as a secondary curve which represents a planned process number per one day;
deciding a third curve by normalizing the first and second curves and calculating a sum of the normalized first and second curves; and
adding a shortage to the second curve if a difference is present between a fourth curve which represents a working result and the third curve.

5. The administering method as claimed in claim 4, wherein a working is continued if, in view of a working result of working in a term of 1/10 of a full term of a working schedule, said fourth curve is identical with or above the third curve, while the working is discontinued if, in view of the working result, said fourth curve is below the third curve.

6. The administering method as claimed in claim 4 or 5, wherein the growth curve is a logistic curve.
